(19) United States
(12) Patent Application Publication
(10) Pub. No.: US 2007/0149076 A1
(43) Pub. Date: Jun. 28, 2007

(54) CUT-RESISTANT COMPOSITE

(75) Inventor: Marc Van Moeseke, Daknam-Lokeren (BE)

Correspondence Address: KNOBBE MARTENS OLSON & BEAR LLP, 2040 MAIN STREET, FOURTEENTH FLOOR, IRVINE, CA, 92614, US

(73) Assignee: Dynatex, Aalbeke (BE)

(21) Appl. No.: 11/678,512

(22) Filed: Feb. 23, 2007

Related U.S. Application Data
(62) Division of application No. 10/661,004, filed on Sep. 11, 2003, now abandoned.

(51) Int. Cl. B32B 27/04

(52) U.S. Cl. 442/134; 442/6; 442/23; 442/52; 442/61; 442/228

(57) ABSTRACT

The present invention relates in a first aspect to a cut-resistant and/or cut-warning composite comprising a matrix, provided on one side of a fabric, a fabric, and at least one insulating layer provided between said matrix and said fabric. In another aspect, the invention relates to a composite, whereby cavities are provided between the individual elements of said fabric. In another aspect, the present invention relates to a method for preventing vandalism on a composite. In another aspect, the invention relates to the use of a composite according to the present invention as an anti-vandalism composite.

### RELATED APPLICATIONS

This application is a divisional of U.S. patent application Ser. No. 10/661,004, filed on Sep. 11, 2003.

### FIELD OF THE INVENTION

The present invention relates to the field of cut-resistant composites and cut-resistant fabrics. In a first aspect, the present invention relates to a cut-resistant composite. In another aspect, the present invention relates to a cut-warning composite. In yet another aspect the present invention relates to a method for preventing vandalism on a composite. In another aspect, the invention relates to the use of a composite according to the present invention as an anti-vandalism composite.

### BACKGROUND OF THE INVENTION

In order to prevent thefts, recently researches have been done to obtain cut resistant materials and constructions. This has already a lot of applications, especially in thermoharding materials. There are also known types of reinforcements for thermoplastic materials as e.g. a knitted “loop” fabric based on a knitted metal loop reinforcement. Also a woven tarpaulin reinforcement is already known comprising woven and knitted steel constructions. These last constructions have as major difficulty, i.e. the stiffness and the weight. The first “loop” knit construction has as major difficulty when it is used as “anti-hooligan” fabric in seats of trains, trams, busses, it may, upon damage pierce and stick through the fabric. So even if it helps a lot to improve cut resistance in the fabric, the seat can no more be used as the metal will pinch through the skin of the user as well.

A major difficulty of the existing fabrics and/or composites is that the fabric reinforcing elements, e.g. yarns, fibers, cables, once embedded and thus connected to a matrix, are acting as individual elements during cutting or perforation. The reinforcing elements are cut through one after the other. For example, when a first yarn is cut, cutting starts at a second yarn. Once the second yarn is cut through, cutting continues at a third reinforcement yarn, and so on. As a consequence, the reinforcement elements which act as individual elements can be more easily cut through and will not provide sufficient cutting resistance to the fabric or composite.

There remains a great need in the art for composites and fabrics having improved cutting resistance.

It is therefore an object of the present invention to provide an improved cut-resistant composite.

It is in particular an object of the present invention to provide a composite, which has higher cutting resistance than currently available composites.

It is also an object of the present invention to provide a cut-warning composite.

In addition, another aim of the present invention is to provide a method for preventing vandalism on a composite. In particular, it is an object of the present invention to provide a method for activating an alarm signal when a composite is being cut through.

### SUMMARY OF THE INVENTION

In a first aspect, the present invention provides a composite having improved cutting resistance. The present invention provides in a composite comprising:
a matrix, provided on at least one side with a fabric, said fabric, comprising at least two layers and/or at least two directions of individual elements of which at least one individual element is reinforced and which elements are interconnected by chemicals, plastics, rubbers and/or by connection elements which connection is weaker than the reinforced element, and
at least one insulating layer interposed between said matrix and said fabric.

By providing an insulating layer between the fabric and the matrix, the present invention provides a composite and/or a fabric wherein the reinforcement elements in the fabric and/or composite will not act as individual elements but will act as a “group” or a “set” of elements. A major advantage of the reinforcement yarns or elements to act as a set of elements is that different elements are able to simultaneously undergo some displacement, when acting upon by a cutting element. As a consequence, individual elements will less easily be cut through, and cutting resistance of the fabric will be greatly improved. The present invention thus provides a composite having maximal cutting resistance, by enabling the anti-cutting or anti-vandalism reinforcement elements to act as free as possible, i.e. by creating “bundles” or “groups” of individual elements before a single element gets cut through.

In addition, in a preferred embodiment, the present invention also provides a composite whereby said fabric comprises free spaces between the individual elements, and whereby preferably the volume of said free spaces in said fabric is greater than the volume of the individual elements.

The presence of free spaces or cavities between the individual elements of the fabric considerably improves the ability of the individual elements acting as a group or bundle of individual elements to undergo some movement or displacement, when acting upon by a cutting element and thus again greatly improves the cutting resistance of the composite.

In a second aspect, the present invention provides a cut-warning composite. The invention provides a composite capable of activating an alarm signal when subjected to acts of vandalism, such as e.g. being cut or pierced through.

In an embodiment, the composite is provided with at least two insulating layers whereby at least one layer is provided on one side of said fabric, and at least one other layer is provided on the other side of said fabric. In a particularly preferred embodiment, at least one insulating layer is able to act as a positive electrical conductor, and at least one other insulating layer is able to act as a negative or neutral electrical conductor, such that connection between said positive with said negative or neutral electrical conductor is capable of activating an alarm signal. As soon as an electrical conducting object such as the steel of a knife, cutter, bore, scraper, or similar object, penetrates through the material, the two insulating layers are brought into contact with each other, a contact is made in the electrical circuit, and an alarm system will be activated.

In another embodiment, the invention provides a composite, which comprises a cut-warning fabric. In accordance with the present invention, the alarm system may be either activated upon a) interruption / cutting off or closure of an electrical circuit provided in the fabric, or b) providing a contact between a positive and a neutral or negative electrical circuit provided in the fabric. One possibility is that the layer of reinforcement elements is acting as a circuit. As soon as one end is cut, the electrical circuit is broken and an alarm goes on. Such type of composite is particularly suitable for preventing acts of vandalism performed with non-conductive, e.g. ceramic cutting elements. Another possibility is that one layer of reinforcement elements is acting as a positive conductor and another layer is acting as a negative or neutral conductor, such that connection between both layers induces an alarm signal. Such type of composite is particularly suitable for preventing acts of vandalism performed with conductive cutting elements.

In a third aspect, the present invention provides a method for preventing vandalism on a composite by activating an alarm signal when the composite is subjected to acts of vandalism, e.g. cut through. The alarm system may be activated when someone tries to cut or cuts through the composite. In accordance with the present invention, the alarm system may be activated upon providing a contact between a positive and a neutral or negative electrical circuit (i.e. the insulating layers or the reinforcement elements) provided in the composite according to the present invention.

In one embodiment, said method for preventing vandalism on a composite comprises
a. providing said composite with a fabric and at least two insulating layers, whereby at least one layer is provided on one side of said fabric and another layer is provided on the other side of said fabric, and whereby at least one of said insulating layers is able to act as a positive electrical conductor, and whereby at least one other insulating layer is able to act as a negative or neutral electrical conductor, and
b. activating an alarm signal when connection between said positive with said negative or neutral electrical conductor is made.

In another embodiment, the invention provides a method for preventing vandalism on a composite by providing said composite with cut-warning fabric. One possibility is that the layer of reinforcement elements in the fabric is acting as a circuit. Another possibility is that one layer of reinforcement elements in the fabric is acting as a positive conductor and another layer is acting as a negative or neutral conductor. As soon as one individual element in the circuit is cut through in the fabric or as soon as a contact is made by a cutter, knife or other cutting element, the alarm goes off.

The cut-resistant and cut-warning composites or any combinations thereof according to the invention are particularly useful as anti-vandalism composites. Those skilled in the art will immediate recognize the many possibilities for end uses of the present invention from the detailed description and accompanying drawings provided below.

### DETAILED DESCRIPTION OF THE FIGURES

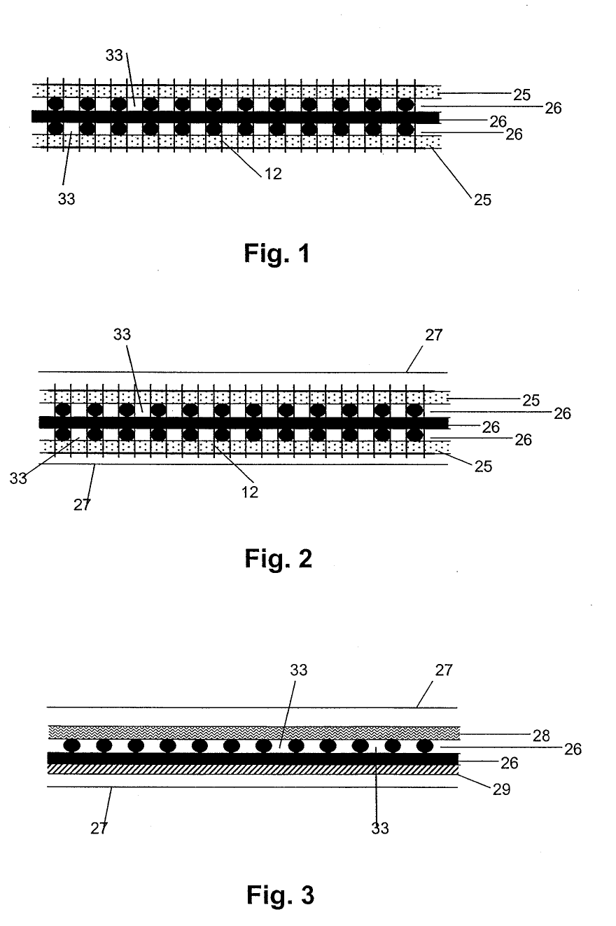

FIGS. 1-9 represent different embodiments of composites according to the present invention.

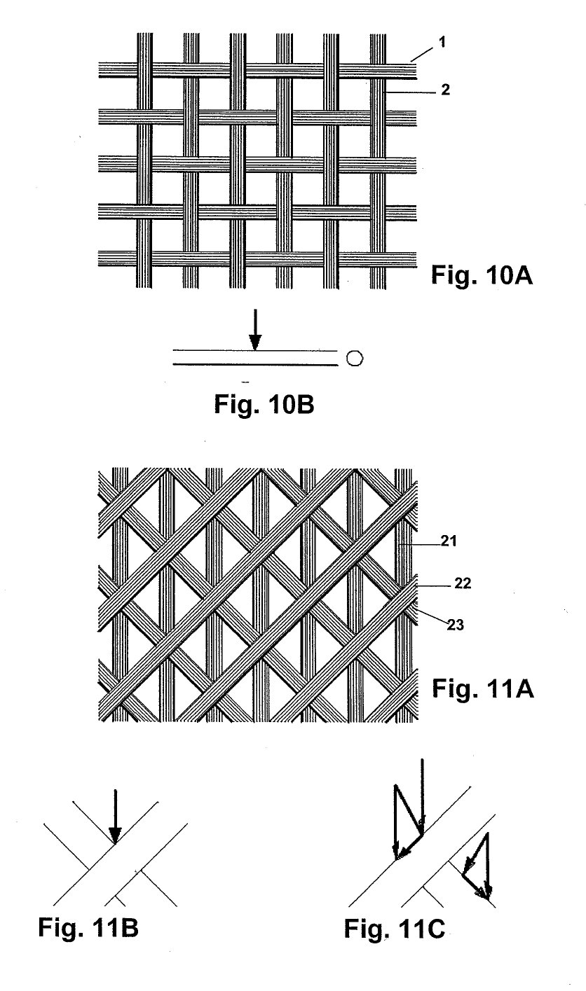

FIG. 10 to 19 represent different embodiments of fabrics comprised in a composite according to the present invention.

FIG. 20 shows another preferred embodiment of a fabric comprised in a composite according to the present invention.

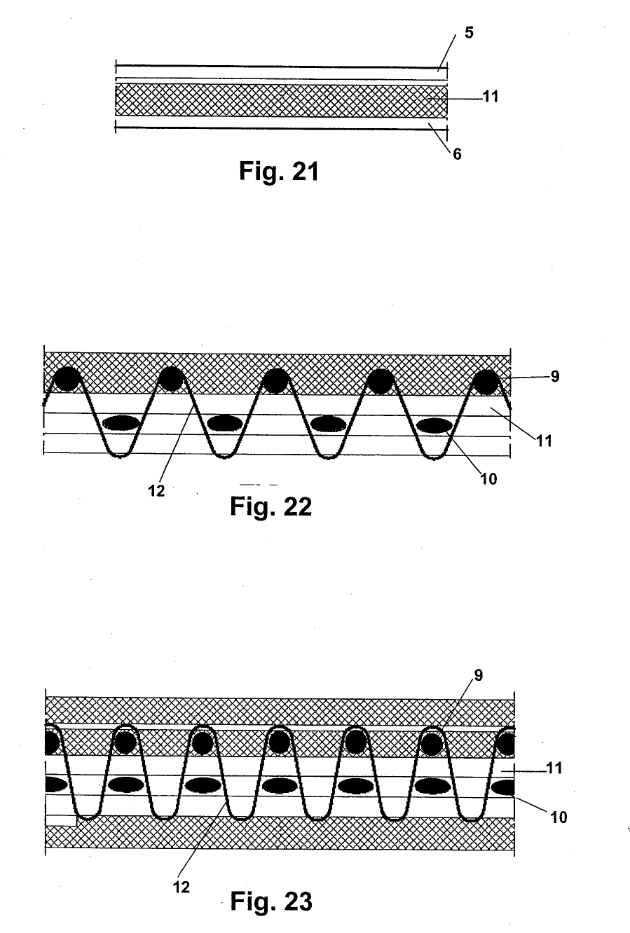

FIG. 21 represents another embodiment of a fabric comprised in a composite according to the present invention having two layers of non-woven individual elements.

FIG. 22 shows another embodiment of a fabric comprised in a composite according to the present invention having layers of insulated individual elements.

FIG. 23 shows yet another embodiment of a fabric comprised in a composite according to the present invention having insulated individual elements and comprising a metal wire per layer of individual elements.

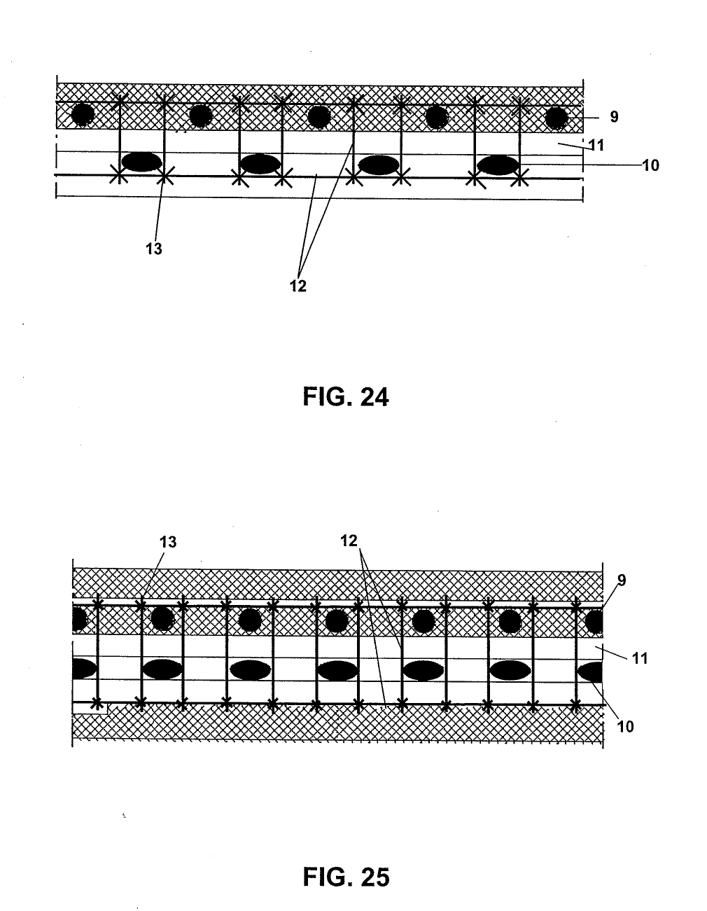

FIG. 24 shows another embodiment of a fabric comprised in a composite according to the present invention having layers of insulated individual elements.

FIG. 25 shows yet another embodiment of a fabric comprised in a composite according to the present invention having insulated individual elements and comprising a metal wire per layer of individual elements.

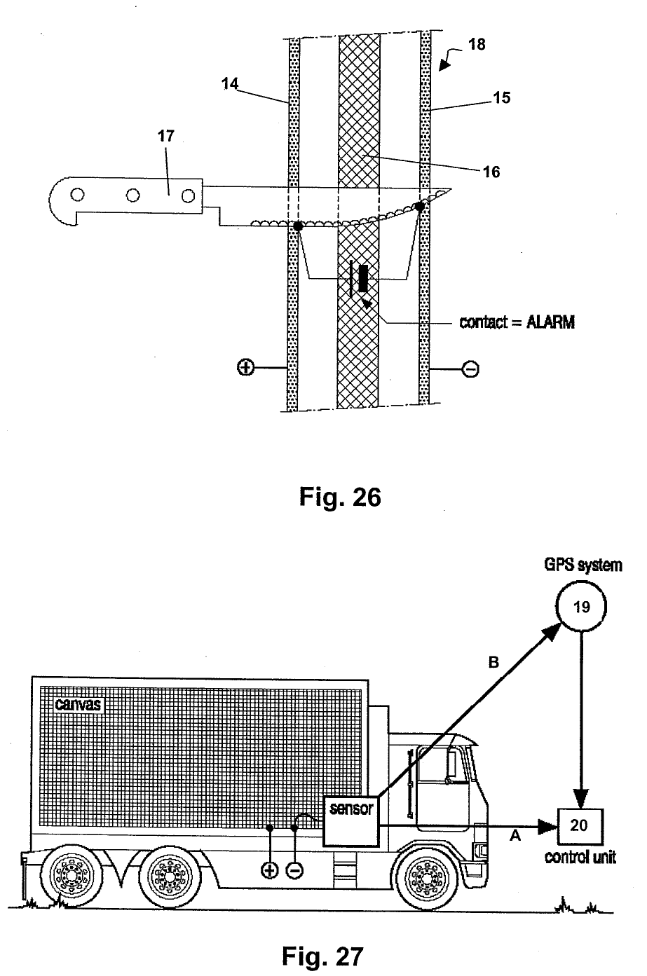

FIG. 26 schematically represents the induction of an alarm system in a fabric comprised in a composite according to the invention, when a canvas is being cut with a knife. The fabric as represented consists of at least two conductive layers, which are separated in relation to each other by insulating material.

FIG. 27 shows the use of a canvas on a truck. The canvas is partly or wholly made of a composite and/or fabric suitable for activating an alarm system according to the invention. The represented composite and/or fabric is provided with a sensor capable of detecting a contact made in an electrical circuit in the composite or fabric or cutting off or closure of an electrical circuit provided in the fabric. Such detection is transmitted either directly or indirectly, e.g. via a satellite system, to a control unit capable of which subsequently releases an alarm signal.

### DETAILED DESCRIPTION OF THE INVENTION

The present invention provides in a first embodiment, a composite that comprises a matrix, provided on at least one side of a fabric, a fabric, and at least one insulating layer interposed between said matrix and said fabric.

The insulating layer is provided in the composite such that said fabric is at most only partly connected to said matrix. The term “at most only partly connected” as used herein refers to the fact that the anti-cutting reinforcement elements in the fabric are either not connected to the matrix, or only partly connected to the matrix.

By providing an insulating layer between the fabric and the matrix, the present invention provides a composite wherein the fabric is either only partly or even entirely insulated from the matrix. Such arrangement has several advantages. In first instance, the fabric has one additional degree of freedom, is able to move independently from the matrix and is therefore more flexible. Furthermore, since the matrix is not, or only partly connected to the matrix, the individual elements in the fabric, e.g. yarns, fibers, etc., are not or only partly connected to the matrix. The individual elements are therefore partly or even completely free to move, independently from the matrix, when a cutting element is brought into the fabric. This ability of the individual elements in the fabric to undergo movements and displacements independently of the matrix will considerably improve the cutting resistance of the fabric and thus also the cutting resistance of the composite. It allows the individual elements to act as a set of elements, and not as individual elements, which are easily cut through as indicated above.

Preferably, the fabric comprises said fabric, comprising at least two layers and/or at least two directions of individual elements of which at least one individual element is reinforced and which elements are interconnected by chemicals, plastics, rubbers and/or by connection elements which connection is weaker than the reinforced element. However, other types of fabrics can be used in the composite according to the invention, as will be explained into more detail below.

In another embodiment the invention relates to a cut-resistant composite comprising:
a matrix, provided on at least one side with a fabric, said fabric comprising at least two individual layers of reinforcement elements whereby in each of said individual layers all reinforcement elements are provided in only one, same direction, said individual layers being interconnected or deposited onto each other, and
at least one insulating layer interposed between said matrix and said fabric.

In an example, the fabric may consist of two, three, four or even more individual layers of reinforcement elements. In particular, in each of these individual layers all reinforcement elements in the layer have only one, same direction. Such individual layers of “single-directed” reinforcement elements can be superimposed onto each other. Alternatively, an insulating layer, e.g. a non woven or a foam layer, can additionally be provided between two individual layers of single-directed reinforcement elements. The different individual layers of “single-directed” reinforcement elements can be arranged under a certain angle with respect to each other. Said angle preferably differs from 90° and is preferably comprised between 1 and 89 degrees, and for example 10, 20, 30, 40, 50, 60, 70 or 80 degrees.

In another embodiment, the composite according to the invention comprises at least two insulating layers whereby at least one layer is provided on one side of said fabric, and at least one other layer is provided on the other side of said fabric. In another embodiment, the composite according to the invention further comprises at least one insulating layer, whereby said layer is provided between two layers and/or two directions of individual elements of said fabric.

In another embodiment, the individual elements in the fabric can also be interwoven as long as this weaving, stitching, suing, or whatever textile construction allows sufficient freedom to the reinforcement yarns. For example a woven fabric 2/2 or even better 3/3 or 4/4 binding will give enough freedom to the fabric when the fabric is not embedded in the matrix.

The invention further relates to a composite wherein the reinforcement elements in the fabric are interconnected and/or connected to the insulating layer. It is important to note that in such type of connection the connection force between interconnected reinforcement elements or between reinforcement elements and the insulating layer, is preferably lower than the force imposed by a cutting element on the reinforcement elements, when said cutting element is forced through the fabric.

As mentioned above, the reinforcement elements in the fabric are not interwoven but have only an indirect connection created by chemicals, plastics, rubbers or by connection elements which are weaker than the reinforced element. Preferably, the insulating layer allows the penetration of stitching and/or knitting and/or tufting needles or combinations thereof so that the reinforcement elements can be connected, e.g. by stitching, knitting, etc. to each other. The reinforcement elements can also be interconnected by means of binding techniques including but not limited to bonding, gluing, or vulcanization or any mixtures thereof.

In another embodiment, the reinforcement elements in the fabric are connected with the insulating layer. Such connection is preferably created by chemicals, plastics, rubbers or by connection elements, such that the connection between said elements and said layer is weaker than the reinforcement element. It will be clear from the present description that the insulating material can also be connected to the reinforcement elements by means of binding techniques including but not limited to bonding, gluing, or vulcanization or any mixtures thereof. The reinforcement elements can also be connected to the insulating layer by means of plastics, rubber, metal coating or connection, melting, intermingling or other casting and/or any combinations thereof.

In a particularly preferred embodiment, the connection, i.e. stitching, gluing, bonding, vulcanization or other type of connection, as those mentioned above, is weaker than the reinforced element. The connection force between interconnected reinforcement elements or between reinforcement elements and the insulating layer, being an adhesive force, a binding strength, an intermingling strength or other force, is preferably lower than the force applied by a cutter, knife or other cutting element on the reinforcement elements so that this connection breaks before one reinforcement end is being cut through. In an example, the reinforcement elements are stitched, tufted or knitted. The strength of the connection created by these stitching, tufting or knitting yarns, acting as binders, is preferably lower than the force of a knife or cutting element on the reinforcement elements, so that this connection will break before the reinforcement elements will be cut through, thereby releasing the reinforcement elements from their fixed place in the fabric.

The above-described type of connection thus enables the reinforcement yarns or elements to act as a “group” or as a “set” of elements, e.g. yarns and not as individual elements, which improves cutting resistance, as explained above.

In a preferred embodiment, the composite material is cut resistant to a force of more than 500 Newton. In another embodiment, the connection elements of the reinforcement have a connection force of e.g. 300 cNewtom/unit.

In another embodiment, the present invention provides a composite whereby free spaces are provided between the individual elements of the fabric. Between the individual elements, e.g. yarns, threads, free or open spaces are provided. In particular, the invention provides a composite whereby the fabric comprises free spaces between the individual elements, and whereby preferably the volume of said free spaces in said fabric is greater than the volume of the individual elements. In a preferred embodiment, the volume of the free spaces in said fabric is comprised between 3% and 99%, preferably is more than 25%, and more preferably more than 50% of the total volume of said fabric. In an example, a volume of free space of 50% preferably enables sufficient displacement of the individual element.

In another preferred embodiment, present invention provides a composite whereby the free spaces are filled up with material selected from the group comprising but not limited to foam materials or elastic materials. The free spaces can be filled up with material such as foam material or foam, having on their own at least 3% and preferably at least 10% non filled spaces. The free spaces may also be filled up with an elastic material, e.g. selected from the group comprising but not limited to polyurethane, rubber, silicone, non-saturated polyester which have an elongation under load which is preferably higher than the reinforcement element under the same load.

In an example, if a filler such as PP foam is used with a specific weight of 0.90 g/cm³, we could look for a weight of 80 kg/m³. This would provide a total free space in % of 100×(900 kg−80 kg)/900 kg=91%.

In another embodiment, the invention relates to a composite wherein the individual elements in the fabric consist of single ends. The term “single ends” refers to the fact that the individual elements of the fabric, being yarns, fibers, etc. . . . are not twisted or cabled, but consist of single yarns, fibers, etc. . . . The fabric in the composite according to the invention thus essentially consists of a set of single individual elements. The advantages of using single yarns or single ends versus twisted or folded and cabled yarns is that single ends have a lower gauge and weight, that they are more flexible and lighter, and that they provide lower costs/kg and lower even more lower costs/surface units.

In a further preferred embodiment, the matrix comprised in a composite according to the present invention comprises thermoplastics and/or thermosets. The term “thermoplastics” as used herein refers to materials that can be made soft by the application of heat and harden upon cooling. The term “thermosets” refers to materials that can no more plastify after setting and/or vulcanization and/or polymerization.

Examples of suitable thermoplastics and/or thermosets for use as matrix material comprise but are not limited to silicone, a metal foil, damped or sputtered metal foil, rubber, a polymer selected from the group comprising, PVC, polyester, polypropylene, polyamide, polyethylene, ethylene/butene copolymers (PEB), poly ethylene terephtalate (PET), polybutyl teraphtalate (PBT), polyvinyldifloride (PVDF), chlorinated PCV, poly urethane (PU), other polymers or mixtures thereof. For instance, for taurpaulins, the matrix material preferably comprises PVC. In another embodiment, the matrix can be finished by applying a lacquer, such as e.g. PVDF.

In another preferred embodiment the insulating layer comprises a foil or a non-woven. Insulation is done by separating, in particular by spatially separating, the reinforcing elements, being yarns, fibers, tapes, etc. . . . , from the matrix and/or matrices on one or both sides of the fabric by providing insulating layers between the matrix and the fabric. The insulating layer is preferably made of material selected from the group comprising silicone, a metal foil, damped or sputtered metal foil (e.g. aluminum), rubber, a polymer selected from the group comprising, PVC, polyester, polypropylene, polyamide, polyethylene, ethylene/butene copolymers (PEB), poly ethylene terephtalate (PET), polybutyl teraphtalate (PBT), polyvinyldifloride (PVDF), poly urethane (PU), chlorinated PVC or other polymers or mixtures thereof.

Non-wovens can be provided in all possible materials including but not limited to PETP, PBT, PA, PP, PE, PU, cellulose and any mixtures thereof. Non-wovens will preferably have a weight between 20-150 g/m², and preferably between 35 and 100 g/m².

Insulation can also be done with a foil, in all possible materials including but not limited to PETP, PBT, PA, PP, PE, PU, cellulose, cellophane, silicone, rubber sheets and any mixtures thereof. Insulation can also be obtained by a combination of a foil and a non-woven, such as but not limited to those described above.

A composite according to the invention may for instance comprise a metal non-woven, i.e. a fabric comprising metal yarns or fibers, and a non woven or foil insulating layer. The metal non-woven is preferably made of metals having a core with a higher melting temperature than the outside material. The core and outside material can also be made of the same material, e.g. steel pressed on each other under warm conditions, or simply connected by thermoplastics, thermosets, glue or any other means. Again, the applied connection force is preferably lower than the cutting force applied by a cutting element on the individual metal fibers or ends.

In another preferred embodiment, the composite according to the invention is provided on at least one side with an adhesive layer. Said adhesive layer is preferably self-adhesive, optionally with a releasing back sheet. The presence of a self-adhesive tape enables the composite to be applied as a tape form, or in a given width. An advantage of this type of composite is that it may be easily used, e.g. in tape form, to replace damaged parts of composites such as canvasses, tarpaulins, seats, chairs, etc. . . . Preferably, the adhesive layer is electro-conductive. As used herein the term “electro-conductive” and “conductive” are used as synonyms and refer to the material property of allowing electrical charge movement.

Depending on the required flexibility of the composite and/or the fabric comprised in the composition, the angle of the reinforcement elements can be chosen. In a preferred embodiment the angle between the individual elements differs from 90°. In order to be flexible enough, the connection angle of the different fibers or elements in the fabric is preferably adapted such that the fabric is stiffer in width direction than in length direction. Therefore, the yarns in the fabric will preferably be arranged under a certain angle with respect to each other. Said angle preferably differs from 90° and is preferably comprised between 1 and 89 degrees, and for example 10, 20, 30, 40, 50, 60, 70 or 80 degrees. As a consequence thereof, it will be impossible for cutting elements to cut through the yarn ends under an angle of 90°. This improves stiffness of the fabric and thus also cutting resistance.

As mentioned above different types of fabrics may be applied in the composites according to the invention.

In an embodiment, the fabric comprises at least two layers and/or at least two directions of individual elements, which might be laid upon each woven, stitched interlink.

In another embodiment, the fabric comprises at least two layers and/or two directions of individual elements of which at least one individual element is a reinforced element comprising a reinforced fiber, which elements are not interwoven but have only an indirect connection created by chemicals, plastics, rubbers or by connection elements which are weaker than the reinforced element.

These fabrics might contain a warp and/or a weft. The difference between “multi-laid” fabric directions and “multi-axial” fabric directions is only in the fact that the individual elements with multi-axial directions are woven, stitched or knitted together lengthwise while for a multi-laid fabric they are kept together by chemical or mechanical means, such as fusion means or a combination thereof.

The term “bias” implies a direction diagonally across a piece of fabric at preferably 45 degrees to the warp and fill. In the present invention the degrees to the warp and fill may differ from 45, in a range of from 1 to 89 degrees, for example 10, 20, 30, 40, 50, 60, 70 or 80 degrees.

“Non-woven” implies material obtained by assembling fibers with other chemical, mechanical, thermal or physical processes than weaving or knitting or stitching, sewing or braiding.

“Knitting means” implies a method for forming a fabric or textile surface produced by interlacing stitches (loops).

The “warp” comprises different warp elements, laying in a same direction, the so-called warp direction. The “weft” comprises different weft elements, laying in a same direction, the so-called weft direction. Each warp and weft element follows a certain path through the fabric, being respectively a warp path or a weft path. According to the invention, at least one warp element or one weft element, or both, comprise two or more elongated steel elements, which are in contact relationship with each other.

According to the invention an “individual element” implies a warp element, preferably a yarn. A warp element is to be understood as one or more individual elements such as e.g. yarns, filaments, bundles of fibers, wires or cords, which follow the same path through the fabric in warp direction. Preferably, but not necessarily, all individual elements of a warp element cross the weft elements of the fabric in an identical way. Weft element is to be understood as one or more individual elements such as e.g. yarns, filaments, bundles of fibers, wires or cords, which follow the same path through the fabric in weft direction. Preferably, but not necessarily, all individual elements of a weft element cross the warp elements of the fabric in an identical way.

Preferably, in an embodiment the cut-resistant fabric comprises at least two layers and/or two directions of individual elements of which at least one individual element is a reinforced element comprising a reinforced fiber, which elements are not interwoven but have only an indirect connection created by chemicals, plastics, rubbers or by connection elements which are weaker than the reinforced element.

Even more preferred at least one side of the fabric is provided with an adhesive layer. In another embodiment, said adhesive layer is self-adhesive, optionally with a releasing back sheet. The presence of a self-adhesive tape enables the fabric to be applied as a tape form, or in a given width. For instance, for the protection of tarpaulins or canvasses of trucks, the recommended width of the stroke of protective material preferably comprises between 80 cm and 130 cm, so that thieves or vandals cannot reach higher without the use of additional helping means, e.g. ladder, on the tarpaulin or canvas. Another advantage of this type of fabric is that the fabric may be easily used, e.g. in tape form, to replace damaged parts of materials such as canvasses, tarpaulins, seats, chairs, etc.

The adhesive layer may consist of conductive or non-conductive material, or a mixture thereof. In a preferred embodiment, said adhesive layer is electro-conductive.

In another preferred embodiment, at least one of the individual elements of the cut-resistant fabric is partly or wholly electro-conductive and at least partly insulated.

In another further embodiment, said electro-conductive material is selected from the group comprising a metal thread, a conductive fiber, a conductive polymer, aluminum foil, damped and/or sputtered metals, e.g. a polyester foil with sputtered or damped aluminum or other metals, damped and/or sputtered aluminum foil or mixtures thereof.

The conductive material may be a metal component, such as a metal thread provided that the metal is conductive and preferably a copper or steel thread. “Conductive polymers” refers to polymers that conduct electric currents without the addition of conductive (inorganic) substances. In another embodiment, the conductive material in the fabric may be a conductive polymer, such as but not limited to polypyrrole, polythiophene, polyaniline, substituted polyaniline, poly(ethylene dioxythiophene), polybutyl teraphtalate (PBT), polyvinyldifloride (PVDF) or other conductive polymers or any mixtures thereof. In a preferred embodiment the co-polymers include PBT, which is suitable as conductive polymers since it provide a good flexibility, and PVDF, which is suitable since this polymer provides resistance to chemical compounds. In another preferred embodiment, the conductive polymers include polypryrrole and polyaniline. Alternatively, the conductive material in the fabric may also be a conductive fiber, such as conductive carbon fibers, carbon filled nylon or carbon filled polyester fibers or others. In another embodiment, the conductive material may also comprise a sputtered metal or mixtures thereof. The conductive material may also comprise conductive aluminum foil that is perforated or not. In a preferred embodiment, the conductive material comprises conductive aluminum foil that is perforated.

In a particularly preferred embodiment, the conductive polymer is capable of being conductive until a predetermined temperature and the polymer looses its conductivity above said predetermined temperature. In particular, in another embodiment the invention provides a composite, which is electro-conductive till a given predetermined temperature and which looses its conductivity as soon as the temperature rises above the predetermined temperature. Therefor, the invention provides the use of a conductive polymer in the fabric of said composite, which is conductive until a predetermined temperature and looses its conductivity above said predetermined temperature. The use of conductive polymers capable of being conductive until a predetermined temperature enables to provide complexes, which can be easily welded to other matrices or to the matrix itself. For instance, the use of such type of conductive polymer can be very interesting to enable or facilitate ultrasonic or electric welding of e.g. PVC matrix. For instance, if conductivity is limited to e.g. 50° C., the conductive polymer is no longer conductive at 51° C. When the welding takes place at 51° C., the material will no more “sparkle” and will not deteriorate the matrix. This could be very interesting for very flexible applications such as soft taps (e.g. car roofs), covers, tarpaulins, etc.

In another further embodiment, the invention relates to a cut-resistant fabric, wherein the insulating material is selected from the group comprising silicone, rubber, PVC, polyester, polypropylene, polyamide, polyethylene, ethylene/butene copolymers (PEB), polyethylene terephtalate (PET), polybutyl teraphtalate (PBT), polyvinyldifloride (PVDF), poly urethane (PU), chlorinated PVC, or mixtures thereof.

In yet another embodiment, the reinforced fibers in said cut-resistant fabric are provided with joints or weakening points for enabling folding of the fabric. For certain application, flexible fabrics are required. This is for instance the case when textiles of the curtain type or the roll-up type, e.g. canvasses or tarpaulins, are to be rolled up in horizontal or vertical direction respectively to open the textiles. Textiles of this type require flexibility vertically. In order to enable the fabric according to the present invention to be easily rolled up or aside, the canvas comprises a fabric having reinforced fibers, which are provided with joints or weakening points for enabling the folding of the fabric.

In another aspect the invention, the fabric applied in the composite according to the invention may comprise a cut-warning fabric.

According to an embodiment of the present invention, such cut-warning fabric comprises at least one layer and/or one direction of individual elements of which said individual elements are partly or wholly made of electro-conductive material and at least partly insulated. In a preferred embodiment said at least one of the individual element is able to act as an electrical conductor suitable for providing an electrical circuit in said fabric. In a more preferred embodiment, the invention relates to a cut-warning fabric wherein the interruption or closure of said electrical circuit in said fabric is capable of activating an alarm signal.

According to another embodiment of the present invention, the mentioned cut-warning fabric comprises at least two layers and/or two directions of individual elements of which said individual elements are partly or wholly made of conductive (electro-conductive) material and are at least partly insulated in relation to each other. In a preferred embodiment at least one of the individual elements is able to act as a positive electrical conductor, and at least another of the individual elements is able to act as a negative or neutral electrical conductor. In a more preferred embodiment, the invention relates to a cut-warning fabric wherein the connection between said positive with said negative or neutral electrical conductor is capable of activating an alarm signal.

In another embodiment, the cut-warning fabric further comprises at least one individual element able to act as a connection thread, for interconnecting the different individual elements able to act as a same electrical conductor.

In yet another embodiment, the cut-warning fabric has individual elements able to act as a same electrical conductor are suitable for ending up in only one pen being connectable to an electrical power supplier. Alternatively in another embodiment, the cut-warning fabric, has individual elements able to act as an electrical conductor are suitable for ending up in a multiple of pens being connectable to an electrical power supplier.

In a preferred embodiment the individual elements in said cut-warning fabric are provided with joints or weakening points for enabling folding of the fabric.

In another further embodiment, the invention relates to a cut-warning fabric, wherein electro-conductive material is selected from the group comprising a metal thread, a conductive fiber, a conductive polymer, aluminum foil, damped and/or sputtered metals, damped and/or sputtered aluminum foil, or mixtures thereof. In a more preferred embodiment, at least one of said individual elements is partly or wholly made of perforated aluminum foil.

In yet another further embodiment, the invention relates to a cut-warning fabric, wherein insulating material is selected from the group comprising silicone, rubber, PVC, polyester, polypropylene, polyamide, polyethylene, ethylene/butene copolymers (PEB), poly ethylene terephtalate (PET), polybutyl teraphtalate (PBT), polyvinyldifloride (PVDF), poly urethane (PU), or mixtures thereof.

A particularly preferred embodiment, the invention relates to a fabric wherein at least one of its individual elements is partly or wholly electro-conductive, and preferably consisting of perforated aluminum foil, that is at least partly provided with insulating material, in particular PVC. The combination of perforated aluminum foil as conductive material and PVC as insulating material is particularly advantageous, since PVC is a thermoplastic material which when forming the layered fabric structure can extrude into the perforations provided in the aluminum foil in order to provide a solid fabric.

In another embodiment, the invention relates to a cut-warning fabric wherein at least one layer and/or one direction of the individual elements is further able to act as an electrical conductor suitable for activating a heating system in said fabric. Therefor, a heating electrical current is provided in the fabric according to the invention by using the same components as used for establishing the alarm system. More in particular, the heating system may be induced by a) contact between a positive and a neutral or negative electrical circuit provided in the fabric according to the present invention; or b) by interruption/cutting off/closure of an electrical circuit provided in the fabric according to the present invention. By providing a heating system in the fabric according to the invention, at the same time use of the fabric in composites for protective textiles such as but not limited to seats, tarpaulins, convertible tops, or roofs, tents, protection fabrics for boats, trucks, cars, pick-up trucks combine in this way heating and security.

The heating system preferably comprises in one direction on a given distance ranging from 3 mm to 50 cm, e.g. 2.5 cm, a metal yarn with good conductivity and in the other direction a yarn embedded with or dipped in a conductive polymer such as polypyrrole and/or polyaniline or others combined or not with carbons or other materials.

In another aspect, the fabric comprises at least two layers and/or two directions of individual elements of which said individual elements are partly or wholly made of electro-conductive material and are insulated in relation to each other according to the above-given description and further comprising at least two layers and/or two directions of individual elements of which at least one individual element is a reinforced element comprising a reinforced fiber, which elements are not interwoven but have only an indirect connection created by chemicals, plastics, rubbers or by a connection elements which are weaker than the reinforced element. This type of fabric enables to combine cutting resistance with the possibility to activate an alarm system when the fabric is subjected to acts of vandalism.

In a preferred embodiment, the invention relates to said cut-resistant and cut-warning fabric wherein said electro-conductive material is selected from the group comprising a metal thread, a conductive fiber, a conductive polymer, aluminum foil, damped and/or sputtered metals, damped and/or sputtered aluminum foil, or mixtures thereof.

In another preferred embodiment, the invention relates to said cut-resistant and cut-warning fabric wherein the insulating material is selected from the group comprising silicone, rubber, PVC, polyester, polypropylene, polyamide, polyethylene, ethylene/butene copolymers (PEB), poly ethylene terephtalate (PET), polybutyl teraphtalate (PBT), polyvinyldifloride (PVDF), poly urethane (PU) or mixtures thereof.

In an even more preferred embodiment, the invention relates to a cut-resistant and cut-warning fabric wherein at least one of said individual elements is partly or wholly made of perforated aluminum foil or damped aluminum foil on (perforated or not perforated) PETP.

In another embodiment, the invention relates to a fabric, wherein said individual elements and said reinforced fibers are provided with joints or weakening points for enabling folding of the fabric.

In yet another aspect of the present invention a cut-resistant and cut-warning fabric is provided as described above, whereon at least on one side an adhesive layer, preferably a self-adhesive layer optionally with a releasing back sheet is provided.

In a preferred embodiment the angle between the individual elements differs from 90°.

In another preferred embodiment the fabric according to the invention has at least two different layers and/or directions of individual elements.

In another preferred embodiment the fabric according to the invention comprises individual elements which are connected by knitting and/or by stitching.

In another preferred embodiment the individual elements are connected by plastic, chemicals or rubber.

In another preferred embodiment the individual elements are connected by another textile means such as non-woven.

In another preferred embodiment the fabric according to the invention comprises a combination of one or more of the connection means.

In another preferred embodiment the fabric contains at least one direction and/or layer which differs to another in an angle other than 90 .

In another preferred embodiment the different individual elements have at least two different compositions of material.

In another preferred embodiment the individual elements are covered by a material by spinning, winding, twisting or any other way to have fibers or filaments around the elements.

In another preferred embodiment at least some of the individual elements are covered by plastic and/or rubber.

In a preferred embodiment the fabric is woven, knitted or braid, or comprises any other textile construction wherein the connection or interweaving takes at least partly place by means of non reinforcement individual elements, as e.g. normal textile yarns, while the major reinforcement individual elements do not have a major part of the woven or knitted connection to each other.

In another preferred embodiment the main reinforcement individual elements are only interwoven, interknit or interconnected at a distance of at least 0.2 mm, preferably 1 mm, more preferably more than 2.5 mm, and more preferably between 2.5 and 5 mm.

In another preferred embodiment the main reinforcement individual elements are only interwoven, interknit or interconnected at a distance of at least 0.5 mm, preferably 5 mm and more preferably more than 10 mm.

In another preferred embodiment the fabric is a multi-axial insertion fabric comprising four main directions, being one warp, one weft and two bias directions and a longitudinal knitted connection thread.

In another preferred embodiment the fabric is a multi-axial weft insertion fabric comprising three main directions being two bias directions and one weft direction and a longitudinal knitted connection thread or yarn.

In another preferred embodiment the fabric is a laid fabric comprising two bias directions and one horizontal weft direction.

In another preferred embodiment the fabric is a laid fabric comprising four reinforcement directions being one weft direction, one warp direction and two bias directions.

In another preferred embodiment the fabric is a bias laid fabric comprising two directions.

In another preferred embodiment the fabric is a bias laid fabric comprising a longitudinal carrier yarn up and/or under the two main directions.

In another preferred embodiment the fabric is a two layer laid fabric In another preferred embodiment the fabric is a three layer laid fabric.

In another preferred embodiment the fabric is a four layer laid fabric.

In another preferred embodiment, the fabric according to the invention is cut resistant to a force of more than 10 Newton.

Taking the above-mentioned features into account the preferred textile constructions will be “weft inserted” knits, laid fabrics, multi-axial fabrics in shape of multi-axial laid fabrics or as multi-axial weft insertion (type Liba and Karl Mayer Malimo) and also stitched materials including the use of non-wovens and all other or any combination of these textile constructions.

In another aspect, the present invention relates to a method for preventing vandalism on a composite. Such method comprises providing the composite with alarm activating means. The alarm activating means may be provided by the insulated layers of the composite. In one embodiment the method for preventing vandalism on a composite comprises providing said composite with a fabric and at least two insulating layers, whereby at least one layer is provided on one side of said fabric and another layer is provided on the other side of said fabric, and whereby at least one of said insulating layers is able to act as a positive electrical conductor, and whereby at least one other insulating layer is able to act as a negative or neutral electrical conductor, and activating an alarm signal when connection between said positive with said negative or neutral electrical conductor is made.

In another embodiment, the present invention also provides a method for preventing vandalism on a composite comprising providing a fabric in said composite which comprises alarm activating means. The alarm system in the fabric may be activated when someone tries to cut or cuts through the fabric. In accordance with the present invention, the alarm system may be either activated upon
a) interruption/cutting off or closure of an electrical circuit provided in the fabric according to the present invention, or
b) providing a contact between a positive and a neutral or negative electrical circuit provided in the fabric according to the present invention.

More in particular, in an embodiment, said method comprises providing a fabric comprising at least two layers and/or two directions of individual elements of which said individual elements are partly or wholly made of electro-conductive material and are insulated in relation to each other and wherein at least one of the individual elements is able to act as an electrical conductor for providing an electrical circuit in said fabric according to the invention, and activating an alarm signal when interruption or closure of said electrical circuit in said fabric is made.

In another embodiment, said method comprises providing a fabric comprising at least two layers and/or two directions of individual elements of which said individual elements are partly or wholly made of electro-conductive material and are insulated in relation to each other and wherein at least one of the individual elements is able to act as a positive electrical conductor, and wherein at least another of the individual elements is able to act as a negative or neutral electrical conductor in said fabric according to the present invention, and activating an alarm signal when connection between said positive with said negative or neutral electrical conductor is made.

It will be understood that the method according to the invention is also capable of activating an alarm system when a fabric is being cut, by means of a combination of the two-above mentioned systems. It is possible that as soon as one element of an electrical circuit is broken or cut, the system will create an alarm. This can be combined with the other system in which an alarm is created a soon as a circuit is created by contact of two conductive elements. In the first system, the cutting element (knife, cutter) can be made of a non-conductive material, while in the second system the penetrating cutting object needs to be conductive.

In another further embodiment, the invention relates to a method, wherein interruption or closure of at least one electrical circuit or connection of at least two electrical circuits in said composite or said fabric induces a signal that is detected by a sensor and that is transmitted either directly or indirectly to a control unit capable of releasing an alarm signal. In both methods as described above, the fabric is provided with a sensor. The sensor is either wireless or not and is in contact with a control unit. The sensor detects a contact or an interruption or closure of a electrical circuit, activates a signal upon detection and transmits the signal to a control unit, which subsequently activates an alarm and/or signal, either visible/hearable or not. Suitable alarm signals may comprise noise, light or a silent contact alarming the police, guards, owners or whoever. It is clear that also combination of these alarm signals is possible. Transmission of the signal from the sensor to the control unit preferably occurs indirectly, via a global positioning system (GPS). This type of transmission advantageously links the alarm signal to a position and enables to localize the site where vandalism on the fabric is performed.

In another embodiment, the detection system may also comprise a sensor so that direct contact to the conductors is not absolutely required. The detection could be going through a code box, so that by introducing e.g. 4 digitals, the alarm could be put on or off. However, the possibility exists to have this “off” time registered in order to avoid thefts with “inside help”.

In another embodiment of this invention, the method comprises providing a fabric wherein the electro-conductive material is selected from the group comprising a metal thread, a conductive fiber, a conductive polymer, aluminum foil, damped and/or sputtered metals, damped and/or sputtered aluminum foil, or mixtures thereof.

In another embodiment the invention relates to a method, wherein a fabric is provided wherein the insulating material is selected from the group comprising silicone, rubber, PVC, polyester, polypropylene, polyamide, polyethylene, ethylene/butene copolymers (PEB), poly ethylene terephtalate (PET), polybutyl teraphtalate (PBT), polyvinyldifloride (PVDF), poly urethane (PU) or mixtures thereof.

The composites according to any of the embodiments of the present invention are particularly useful to be used as an anti-vandalism composites. In particular in another aspect, the present invention relates to the use of a composite according to any of the previous embodiments as an alarm activating composite and/or a cut-resistant composite.

In further preferred embodiment the composite according to the invention may comprise a tarpaulin or a cover. In order to protect the entire tarpaulin connections such as cords, TIR cords or cables and/or tapes will also be preferably reinforced and connected with an alarm system.

In another preferred embodiment, the composite according to the invention comprises a canvas. As used herein the term “canvas”, is to be understood in the largest way. Protective canvasses, to be used e.g. on trucks, containers or trains are to be understood as protective textiles. Canvasses for different uses may be provided, e.g. canvasses for trucks may be of the curtain type or of the roll-up type. Canvasses of the curtain type are slidingly suspended on horizontal rails and can be horizontally slid to one side to open the canvas. Canvasses to the curtain type require flexibility in the horizontal direction. Canvasses of the roll-up type can be rolled up vertically to open the canvas. Canvasses of the roll-up type require flexibility vertically.

In another preferred embodiment, the composite according to the invention comprises a “convertible” for cars or other transport vehicle. In convertible roofs of cars and other transport vehicles the accent will be even more one the alarm system. A part or the whole of the fabric can be made conductive by e.g. a polymer such as polypyrrole and/or polyaniline and others, this will provide the advantage that the fabric will remain very soft and thus very good foldable. As already mentioned, this could be combined with a heating system so that detection as well as ultrasonic welding at a given temperature would be possible. A heating system requires the necessity of having a lower heat transmission from the inside to the outside. A foam layer based on PU, PP, PE or other polymers could be used.

In another preferred embodiment, the composite according to the invention comprises a luggage or a parcel or another packing material.

In another preferred embodiment, the composite according to the invention comprises an upholstery composite reinforced in the form of seats chairs.

In another preferred embodiment, the composite according to the invention comprises a flexible in preference but also non-flexible door, gate.

In another preferred embodiment, the composite according to the invention comprises a shelter and/or tent.

In another preferred embodiment, the composite according to the invention comprises a temporary wall or fence as used for exhibition rooms.

In another preferred embodiment, the composite according to the invention comprises a tape, preferably self-adhesive tape, or zipper or other fastening means. Zippers may be provided which are reinforced to be cut-proof and can be connected to an alarm system as well.

In another preferred embodiment, the composite according to the invention comprises a rope.

In another preferred embodiment, the composite according to the invention comprises a filter.

In another preferred embodiment, the composite according to the invention comprises a gas absorber or liquid absorber suitable for use in the cabin of a vehicle for preventing the entry of toxic gases in said cabin. For instance, in order to protect a driver from toxic and noxious gases a filter comprising the fabric according to the invention may be provided in the air refresher system of the vehicle so that noxious gases are eliminated. In addition, a connection to an alarm system may be provided by means of the used fabric, enabling the activation of the alarm system when the gas/liquid absorber gets in action or reaches a critical value.

In another preferred embodiment, the composite according to the invention may also be applied around a hose, a tube, a pipe or the like. The composite may be wrapped around such elements for strengthening. In view hereof, the angle between the individual elements in the fabric will preferably comprise between 51 and 89 degrees, and for example 31 degrees.

The invention is further elucidated with reference to the examples and drawings wherein several composites and/or fabrics according to the invention are depicted.

### EXAMPLES

In a first example, a composite according to the present invention is represented in FIG. 1. The composite comprises a matrix (not represented), three layers of individual elements (e.g. metal yarns) 26 which are provided on their outside surface with an insulating layer 25, in particular a non-woven. Further represented is a knitted connection thread 12, interconnecting the insulating layer 25 and the layers of individual metal yarns 26. The figure further represents the free spaces 33, provided between the individual elements in the layers of individual elements 26.

FIGS. 2 to 9 represent other embodiments of a composite according to the present invention comprising insulating layers, a fabric and a matrix.

In FIG. 2 the composite comprises three layers of individual yarns 26, e.g. steel yarns having a diameter of 0.175 mm, which are provided on their outside surface with non woven insulating layers 25. The non-woven layers 25 are provided between the yarns and the matrix 27, in particular a plastic (e.g. PVC) coat. Further represented is a knitted connection thread 12, interconnecting the insulating layer 25 and the layers of individual metal yarns 26. The figure further represents the free spaces 33, provided between the individual elements in the layers of individual elements 26.

FIG. 3 represents another embodiment of a composite according to the present invention. The composite comprises insulating layers 28, 29, which are provided between the matrix 27 and two layers of individual elements, e.g. steel yarns 26 having a diameter of 0.150 mm and surrounded with PETP fibers and glued together. The ratio steel/PETP may comprise 50/50. The upper insulating layer 28 may be a foam layer of e.g. 80 g/m², the lower insulating layer 29 may be a plastic foil with a thickness of 0.10 mm. The figure further represents the free spaces 33, provided between the individual elements in the layers of individual elements 26.

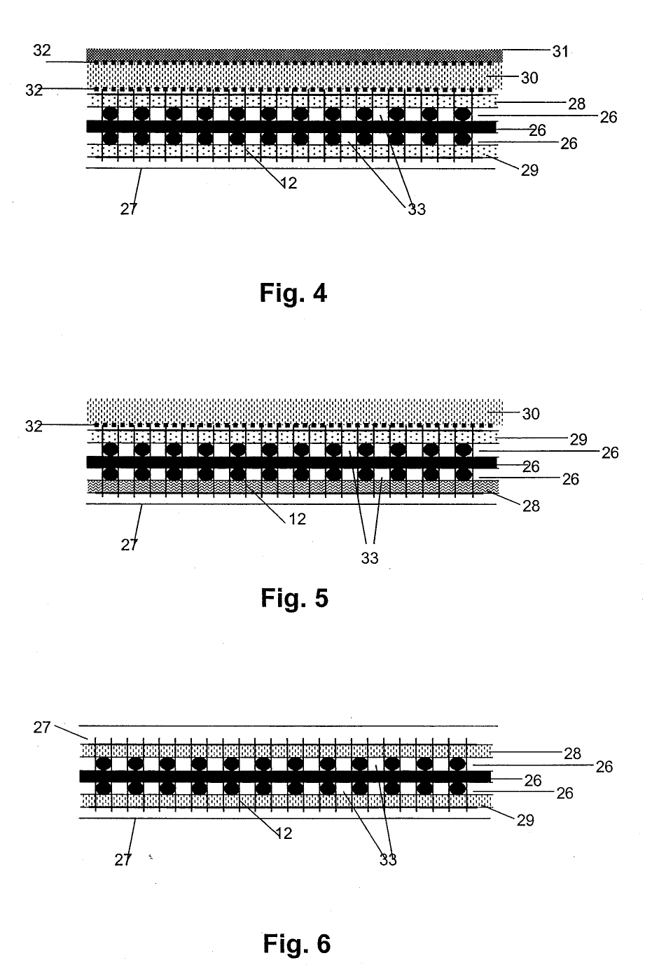

FIG. 4 represents another embodiment of a composite according to the present invention. The composite comprises insulating layers 28, 29, e.g. a non woven or a foil, that are provided on the outside of three layers of individual yarns 26, e.g. steel yarns 26 having a diameter of 0.20 mm. Further represented is a knitted connection thread 12, interconnecting the insulating layer 28, 29 and the layers of individual metal yarns 26. The composite further comprises an aluminum foil 30, e.g. damped aluminum foil on a PETP foil, glued 32 on one of the insulating layers 28 and a PVC or rubber coating layer 27, provided on another insulating layer 29. The composite is further provided with a releasable back sheet 31, which is glued 32 on the aluminum foil 30. It is preferred that the glue does not react or interfere with softeners and/or ozone absorbers. The figure further represents the free spaces 33, provided between the individual elements in the layers of individual elements 26.

FIG. 5 represents another embodiment of a composite according to the present invention. The composite comprises insulating layers 28, 29, e.g. a non woven and a foam layer, that are provided on the outside of three layers of individual yarns 26, e.g. steel yarns 26 having a diameter of 0.20 mm. Further represented is a knitted connection thread 12, interconnecting the insulating layers 28, 29 and the layers of individual metal yarns 26. The composite further comprises an aluminum foil 30, e.g. damped aluminum foil on a PETP foil, glued 32 on one insulating layer 29, and a PVC or rubber coating layer 27, provided on the other insulating layer 28. Free spaces 33 are provided between the individual elements in the layers of individual elements 26.

FIG. 6 represents another embodiment of a composite according to the present invention. The composite comprises two insulating layer 28, 29, e.g. aluminum foils, that are provided on the outside of three layers of individual yarns 26, e.g. steel yarns 26 having a diameter of 0.20 mm. The composite further comprises a PVC or rubber coating layer 27, provided on either side of the insulating layers 28, 29. One of the insulating layers 28 acts as a positive conductor, while the other insulating layer 29 acts as a negative conductor. When an electrically conducting material, e.g. a knife, brings both conductive layers in connection to each other, a signal is detected and transmitted to a control unit, which will generate an alarm signal. Free spaces 33 are provided between the individual elements in the layers of individual elements 26.

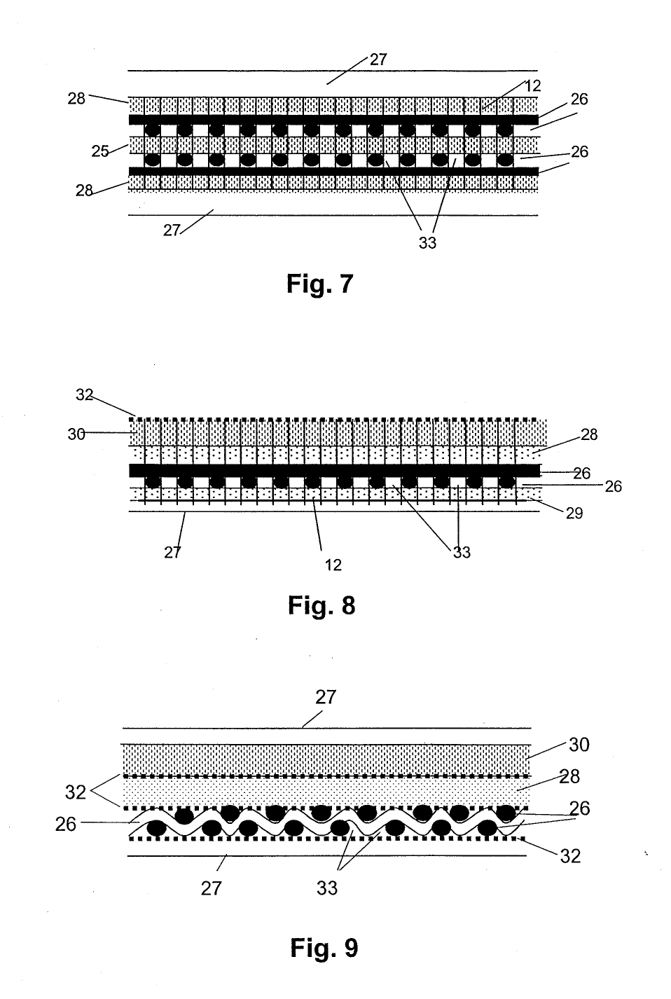

FIG. 7 represents another embodiment of a composite according to the present invention. The composite comprises four layers of individual elements 26, preferably consisting of metal or other conductive yarns (e.g. steel yarns). The composite further comprises an insulating layer 25 between two layers of reinforcement elements 26, so that a part of the conductive yarns are insulated versus other conductive yarns. In addition, a matrix (coating) 27 is provided on the lower side and the upper side of the composite, separated from a layer of reinforcement elements 26 by means of an insulating layer 28. The whole is stitched or sewed together with a non conductive yarn 12. Free spaces 33 are provided between the individual elements in the layers of individual elements 26.

FIG. 8 represents another embodiment of a composite according to the present invention. The composite comprises two layers of individual elements 26, preferably consisting of metal or other conductive yarns (e.g. steel yarns). The composite further comprises insulating layers (e.g. non woven) 28, 29 on either side of the two layers of reinforcement elements 26. A coating (e.g. PVC, PVCC) is provided on top of one of the insulating layers 29. In addition, a damped or sputtered aluminum or other metal foil 30 is provided on top of one of the insulating layers 28. On top of this foil 30 glue 32 can be provided, which is preferably resistant against softeners and ozone. The whole is stitched or sewed together with a non conductive yarn 12. Free spaces 33 are provided between the individual elements in the layers of individual elements 26.

FIG. 9 represents another embodiment of a composite according to the present invention. The composite comprises two layers of interwoven individual elements 26, preferably consisting of metal or other conductive yarns (e.g. steel yarns). The composite further comprises an insulating layer (e.g. non woven) 28 provided by means of glue, a thermoset or thermoplastic material 32 on one side of a layer of reinforcement elements 26. In addition, a conductive foil 30 is provided on top of the insulating layer 28 by means of glue, a thermoset or thermoplastic material 32. On top of this foil 30 glue, or a coating layer 27 can be provided. Free spaces 33 are provided between the individual elements in the layers of individual elements 26.

Hereunder, a few examples of fabrics, suitable for being used in the composite according to the invention are provided.

In an example, a fabric may contain a warp and a weft. The warp ends may contain fully or partially insulated individual elements of conductive material, and the weft may have non-insulated or partially or fully insulated individual elements of conductive material. An example could be a steel thread covered with plastic as PVC, PP, PA, PETP, PEB, PBT, PVDF, or any mixture thereof or could be covered with an insulating yarn spun or twisted or braided around the thread.

In another example, as represented on FIG. 20, such fabric may comprise a weft reinforcement individual element 1 and a warp reinforcement individual element 2, a weft binding individual element 3 and a warp binding individual element 4 whereby the reinforcement individual elements 1 and 2 do not bind each other or if wanted only at wider distances, e.g. 0.5, 1 or 3 mm, the way of binding can be changed and the number of ends or picks of as well individual elements and binding elements can be different than one on any row. In the represented example, the fabric comprises non-insulated weft reinforcement individual element 1 and insulated warp reinforcement individual element 2, which are made of conductive material. As soon as someone tries to cut through the presented fabric, the insulated warp ends will be brought into contact with the non-insulated weft yarns, as the insulation will disappear when cutting through. This contact will activate an alarm.

In another example of a fabric according to the present invention is represented on FIG. 21. The fabric comprises two layers of non-woven individual elements 5, 6 of which one serves as a positive layer 5, the other one as a negative or neutral layer 6. They can be insulated one versus the other by a insulating material 11, e.g. of polyethylene, rubber, PVC, polypropylene, polyamide, polyester or other coatings or any combination thereof. The non-woven elements comprise conductive material, e.g. conductive fibers or conductive polymers.

In yet another example, as represented on FIG. 22, the fabric comprises insulated non-woven elements, insulated warp reinforcement individual elements 9 and insulated bias individual elements 10. Insulating knitted connection thread 12 is provided, stitching through the fabric and keeping all ends together by knitting. The cutting resistant yarns are insulated by at least one non-conductive layer 11 separating the conductive yarns layers. Again, contact can be made or disrupted by connecting the different layers of conductive yarn ends.

Alternatively, the fabric may comprise, as represented on FIG. 23 insulated non-woven individual elements 9 and insulated bias individual elements 10, which are made of conductive material. Insulating knitted connection thread 12 is provided, stitching through the fabric and keeping all ends together by knitting. The cutting resistant yarns are insulated by at least one non-conductive layer 11 separating the conductive yarns layers. To have a good contact the fabric may have one flat metal wire; preferably copper wire per layer of yarns.

FIG. 22 and 23 provide a schematic representation for the concept of providing a knitted connection thread. A more detailed representation of the knitted connection thread is provided in FIG. 24 and 25. FIG. 24 and 25 represent a fabric as in FIG. 22 and 23, respectively wherein the connection thread is knitted up and down through the fabric forming knots or connections 13, which are interconnected.

FIG. 26 is a schematic representation of an activation mechanism of the alarm system. In this figure a reinforced fabric 18 is represented comprising at least two conductive layer 14, 15 being insulated 16 in relation to each other. One of the layers acts as a positive conductor 14, while the other layer acts as a negative conductor 15. When an electrically conducting material, e.g. a knife 17, brings both conductive layers in connection to each other, a signal is detected and transmitted to a control unit, which will generate an alarm signal.

FIG. 27 is a schematic representation of the alarm system. A truck comprises a canvas capable which is partly or wholly made of a fabric suitable for activating an alarm system according to the invention. The represented fabric is provided with a sensor capable of detecting a contact made in an electrical circuit or cutting off or closure of an electrical circuit provided in the fabric. Such detection is transmitted either directly A or indirectly B, e.g. via a satellite system 19 such as a global positioning system (GPS), to a control unit 20, which subsequently activates an alarm signal.

In a preferred embodiment of the present invention, the alarm system can be interrupted or inactivated from a certain distance.

FIGS. 10b, 11c, 12b, 12c, 12d depict the force vectors in the plane of force elucidating the enhanced cutting resistance aspect of the fabrics of the present invention.

FIG. 10b elucidates the force vector of a prior art fabric while the other figures depict the force vectors acting upon fabrics according to the invention. The active (downward) force vector, for example the result of a vandalism action by a cutting knife on the yarns of the present invention (FIGS. 11-19) will be resolved in the plane of force into a cutting force vector acting perpendicular on the individual yarn and a rest force vector. It is clear that the rest force vector is zero on a fabric according to the prior art (FIG. 10a), while on a fabric according to the invention (FIGS. 11-19) a positive rest force vector will be present and therefore reducing the active downward force vector into a smaller cutting force vector acting perpendicular on the individual yarns. It is clear that due to the bias directions and/or bias layers, there is a considerable loss of the cutting force (perpendicular on the yarns).

Furthermore, due to the weak connections between the individual elements or yarns and the downward directed active force vector, several individual elements will be loosened and will be collected together and form a resistant barrier presenting a high cutting resistance. It is clear that the cutting resistant value increases surprisingly high with a fabric according to the present invention whereof the examples are depicted in FIGS. 11-19.

FIG. 11a shows a bias laid fabric comprising a longitudinal reinforcement yarn up 21 and two bias directions 22, 23; three main enforcements bond together.

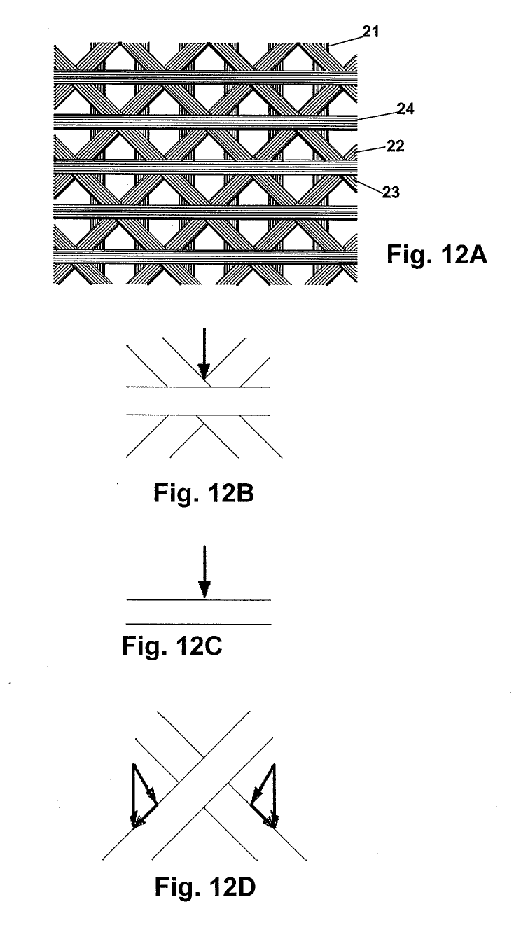

FIG. 12a shows a four laid fabric comprising a longitudinal reinforcement yarn up 21, a horizontal reinforcement yarn up 24 and two bias directions 22, 23; four main enforcements bond together.

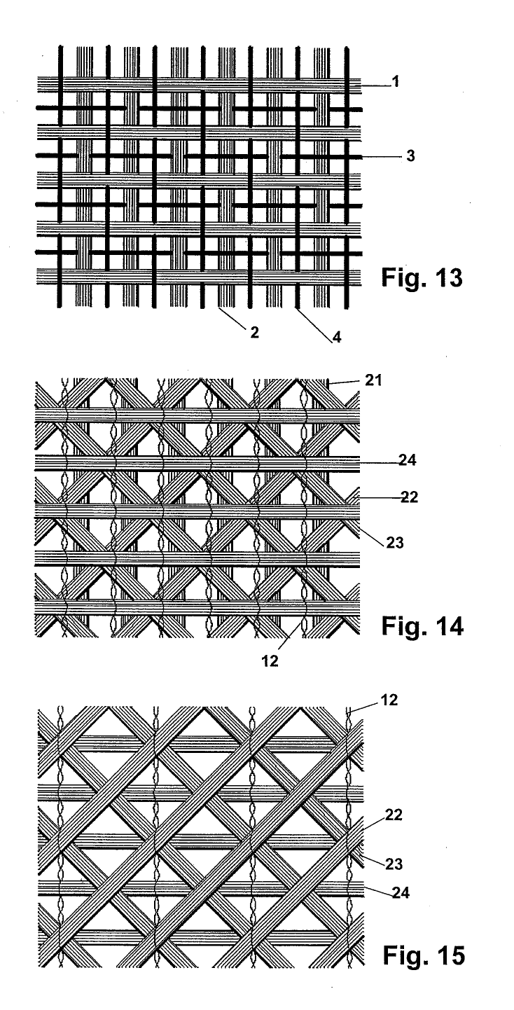

FIG. 13 shows a fabric according to invention comprising a weft reinforcement individual element 1 and a warp reinforcement individual element 2, a weft direction binding individual element 3 and a warp direction binding individual element 4 whereby the reinforcement individual elements 1 and 2 do not bind each other or if wanted only at wider distances, e.g. 3 mm, the way of binding can be changed and the number of ends or picks of as well individual elements and binding elements can be different than one on any row.

FIG. 14 shows a multi-axial insertion fabric comprising four main directions, being one warp 21, one weft 24 and two bias directions 22, 23 and a longitudinal knitted connection thread 12, stitching through the fabric and keeping all ends together by knitting.

FIG. 15 shows a multi-axial weft insertion fabric comprising three main directions being two bias directions 22, 23 and one weft direction 24, and a longitudinal knitted connection thread or yarn 12.

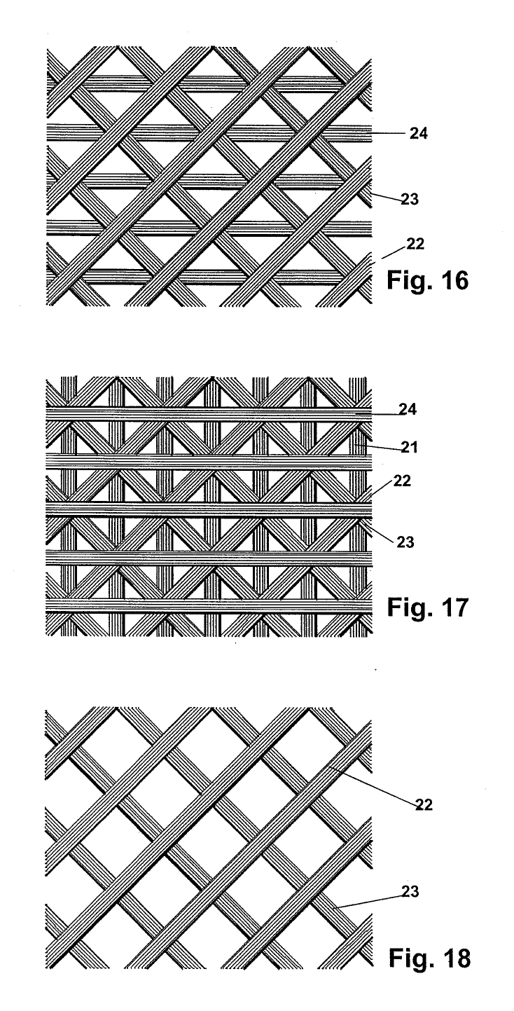

FIG. 16 shows a laid fabric comprising two bias directions 22, 23 and one horizontal weft direction 24. The connections are made by chemical means, e.g. rubber, PVC, PVA, PP, PE, PBT, PVDF, mixtures thereof or other means of chemical bonding.

FIG. 17 shows a laid fabric comprising four directions being one weft direction 24, one warp direction 21 and two bias directions 22, 23.

FIG. 18 shows a bias laid fabric comprising two directions 22, 23.

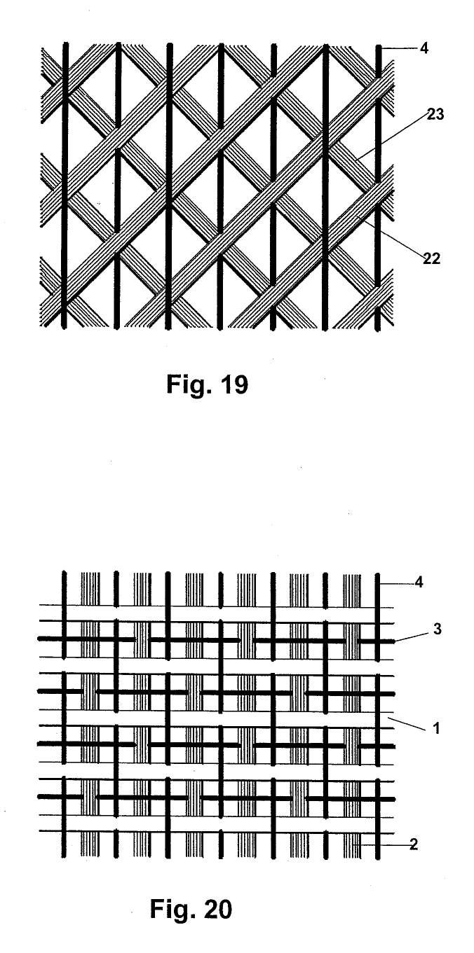

FIG. 19 shows a bias laid fabric comprising a longitudinal carrier yarn 4 up and under the two main directions 22, 23.

All these laid fabrics are bond; this means the ends are kept together by chemical or fusion bonding or combinations thereof.

It will be evident that there are numerous other embodiments of the present invention, which, while not expressly described above, are clearly within the scope and spirit of the invention and are the equivalents thereof. The above description is therefore to be considered to be exemplary only, and the actual scope of the invention is to be determined solely from the appended claims.

What is claimed is:

1. A cut-resistant composite comprising:
a matrix, an intermediate insulating layer and a reinforced fabric,
wherein said insulating layer is adapted to spatially separate the fabric from the matrix,
wherein said reinforced fabric is a non-woven, laid fabric that is cut resistant to a force of more than 10 Newton and consists of two, three, four or more individual layers of reinforcement elements,
wherein all layers of reinforcement elements are superimposed onto each other within said fabric under an angle with respect to each other which is between 1 and 89°,
wherein said layers are connected with each other by a connection that is weaker than the reinforcement element in said layers,
wherein in each of said individual layers, all reinforcement elements are provided in only one same direction, and
wherein said reinforcement elements contain metal or steel thread and are not interwoven.

2. The composite according to claim 1, whereby said fabric comprises free spaces between the individual elements, and whereby the volume of said free spaces in said fabric is greater than the volume of the individual elements.

3. The composite according to claim 2, whereby the volume of the free spaces in said fabric is comprised between 3% and 99% of the total volume of said fabric.

4. The composite according to claim 1, comprising at least two insulating layers whereby at least one layer is provided on one side of said fabric, and at least one other layer is provided on the other side of said fabric.

5. The composite according to claim 4, wherein at least one insulating layer is able to act as a positive electrical conductor, and wherein at least one other insulating layer is able to act as a negative or neutral electrical conductor.

6. The composite according to claim 5, wherein the connection between said positive with said negative or neutral electrical conductor is capable of activating an alarm signal.

7. The composite according to claim 1, further comprising at least one insulating layer, whereby said layer is provided between two layers and/or two directions of individual elements of said fabric.

8. The composite according to claim 1, wherein the insulating layer and the matrix are made of material selected from the group consisting of silicone, a metal foil, damped or sputtered metal foil, rubber, and a polymer which is selected from the group consisting of PVC, polyester, polypropylene, polyamide, polyethylene, ethylene/butene copolymers (PEB), poly ethylene terephtalate (PET), polybutyl teraphtalate (PBT), polyvinyldifloride (PVDF), poly urethane (PU), and chlorinated PVC (PVCC), or other polymers or mixtures thereof.

9. The composite according to claim 1, whereon at least one side of said composite is provided with an adhesive layer.

10. The composite according to claim 9, wherein said adhesive layer is self-adhesive, optionally with a releasing back sheet.

11. The composite according to claim 11, wherein said adhesive layer is electro-conductive.

12. The composite according to claim 1, wherein at least one of the reinforcement elements is electro-conductive and insulated.

13. The composite according to claim 12, wherein said electro-conductive material is selected from the group consisting of a metal thread, a conductive fiber, a conductive polymer, aluminum foil, damped and/or sputtered metals, damped and/or sputtered aluminum foil, and mixtures thereof.

14. The composite according to claim 12, wherein the insulating material is selected from the group consisting of silicone, rubber, PVC, polyester, polypropylene, polyamide, polyethylene, ethylene/butene copolymers (PEB), poly ethylene terephtalate (PET), polybutyl teraphtalate (PBT), polyvinyldifloride (PVDF), poly urethane (PU), chlorinated PVC (PVCC), and mixtures thereof.

15. The composite according to claim 1, wherein the reinforcement elements in the fabric have an indirect connection with the insulating layer, said connection being created by chemicals, plastics, rubbers or by connection elements, such that the connection force between said elements and said layer is weaker than the reinforcement elements.

16. The composite according to claim 1, wherein the reinforcement elements in said fabric consist of single ends.

17. The composite according to claim 1, wherein the reinforcement element is provided with joints or weakening points for enabling folding of the composite.

18. The composite according to claim 1, wherein said composite is selected from the group consisting of a tarpaulin; a cover; a canvas; a “convertible” for cars or other transport vehicle; a luggage or a parcel or another packing material; an upholstery composite reinforced in the form of seats chairs; a flexible in preference but also non-flexible door; a shelter and/or tent; a temporary wall or fence as used for exhibition rooms; a tape or zipper or other fastening means, preferably self-adhesive tape; a rope; a filter; and a gas absorber or liquid absorber suitable for use in the cabin of a vehicle for preventing the entry of toxic gases in said cabin.
